(19) United States
(12) Patent Application Publication
(10) Pub. No.: US 2008/0120648 A1
(43) Pub. Date: May 22, 2008

(54) SYSTEM AND METHOD TO CHANGE STATIONS AND START PROGRAMMING AT BEGINNING OF SEGMENTS

(76) Inventors: MICHAEL P. CARLSON, Austin, TX (US); LINDA A. LISLE, Cedar Park, TX (US); HERMAN RODRIGUEZ, Austin, TX (US)

Correspondence Address: Greg Goshorn, P.C., 9600 Escarpment, Suite 745-9, AUSTIN, TX, 78749, US

(21) Appl. No.: 11/562,202

(22) Filed: Nov. 21, 2006

(51) Int. Cl. G06F 3/00

(52) U.S. Cl. 725/39

(57) ABSTRACT

Provided is a method for caching a media stream such as a television channel or a radio station such that a viewer or listener may receive an entire programming segment regardless of when in the segment the stream is accessed. The beginning of a segment is recalled, or downloaded, to a local cache during a switch to the channel transmitting the segment and associated with a playback marker. The segment is also cached as the segment is transmitted. The user views the segment from the beginning, first from the cache downloaded when the channel is switched and, then, from the local cache stored as the programmed is viewed. In the case of broadcast media, a number of streams are designated as monitored streams. The programming on monitored streams is segmented into programs or smaller segments and the segments are cached on local memory as the programs are broadcast.

### TECHNICAL FIELD

The present invention relates generally to multimedia content and, more specifically, to a method for changing media streams in a manner that allows the beginning of programming segments to be viewed.

### BACKGROUND OF THE INVENTION

In the world today, there are many different streams, or channels, of information and entertainment. With so many programming choices, viewers frequently change the channel from one program to another. This type of activity is often referred to as “channel surfing.” One issue with channel surfing is that often the channel is changed to a program that is in the middle of a programming segment. For example, if a viewer changes to a news channel, an interesting story may be reaching the end, thus causing the viewer to either miss the bulk of the story or be forced to wait until the story is repeated at a later time.

Current technology does not enable a consumer to recapture portions of programming that have occurred prior to the point in time the consumer tunes in to the programming. Consumers thus may only be able to view a fraction of a particular programming choice, which may have cost a producer of such content a large amount of money to produce. Both consumers and producers have a vested interest in providing the consumer with a means to access content in its entirety.

What is needed is a method of providing a viewer with an entire programming segment regardless of when the particular segment is tuned in. If, for example, a viewer turns into a news story after the beginning of the segment, the viewer should have the option to view the particular segment from the beginning. In the alternative, the viewer should have the option to view the entire news program from the beginning.

### SUMMARY OF THE INVENTION

Provided is a method for caching a media stream such as a television channel or a radio station such that a viewer or listener may receive an entire programming segment regardless of when in the segment the stream is accessed. For example, if a user changes to a news channel on a television, the claimed technology enables the user to elect to view a particular story, or the entire news program, from the beginning rather than merely from the point in time that the stream was first received.

The claimed technology employs a local storage to denote and cache a current content of a particular segment. In the case of Internet protocol (IP) television, or “web-TV,” the beginning of a segment is recalled, or downloaded, to a local cache during a switch to the channel transmitting the segment. Playback markers are associated with data blocks of the cache. The current streaming of the segment is also cached as the segment is transmitted. The user views the segment from the beginning, first from the cache downloaded when the channel is switched and, then, from the local cache stored as the programmed is viewed.

In the case of broadcast television or radio, a number of channels or stations, respectively, are designated as monitored streams. The programming on monitored streams is segmented into programs or smaller segments and the segments are cached on local memory as the programs are broadcast. For example, a movie channel is designated as a monitor stream and each movie is cached when the movie begins. A playback marker is associated with a data block corresponding to the start of the movie. If the viewer accesses the movie in the middle, the entire movie is displayed starting from the cached portion associated with the playback marker. In the alternative, segments may be associated with a playback marker based upon the detection of a commercial and only a particular segment such as a scene following the latest commercial is cached.

Once a program or segment has concluded, if the monitored channel has not been accessed, the cache is typically deleted to make room for the next program or segment. Of course, with improvements in storage technology, the amount of cached material may cease to be an issue and entire programs or multiple programs and/or segments may remain in the cache at any particular point in time.

This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description.

### BRIEF DESCRIPTION OF THE FIGURES

A better understanding of the present invention can be obtained when the following detailed description of the disclosed embodiments is considered in conjunction with the following figures, in which:

FIG. 1 is an exemplary multimedia system architecture that includes a programming cache device (PCD), implemented according to the claimed subject matter.

FIG. 2 is a block diagram of the PCD of FIG. 1 in more detail.

FIG. 3 is an exemplary ChacheDescriptorObject (CDO) memory object employed in one implementation of the claimed subject matter.

FIG. 4 is a flowchart of an exemplary Execute Program Cache Device Logic (PCDL) process for implementing one embodiment of the claimed subject matter.

FIG. 5 is a flowchart of an exemplary Create Cache process for implementing one embodiment of the claimed subject matter.

FIG. 6 is a flowchart of a Display Channel process employed to implementing one embodiment of the claimed subject matter.

### DETAILED DESCRIPTION OF THE FIGURES

Although described with particular reference to an IP-enabled television, the claimed subject matter can be implemented in any media content distribution system in which convenience of access is desirable. Those with skill in the computing arts will recognize that the disclosed embodiments have relevance to a wide variety of computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for recalling selected media content at arbitrary times such that portions of the content are not missed. The term “programmed method”, as used herein, is defined to mean one or more process steps that are presently performed; or, alternatively, one or more process steps that are enabled to be performed at a future point in time. The term programmed method anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

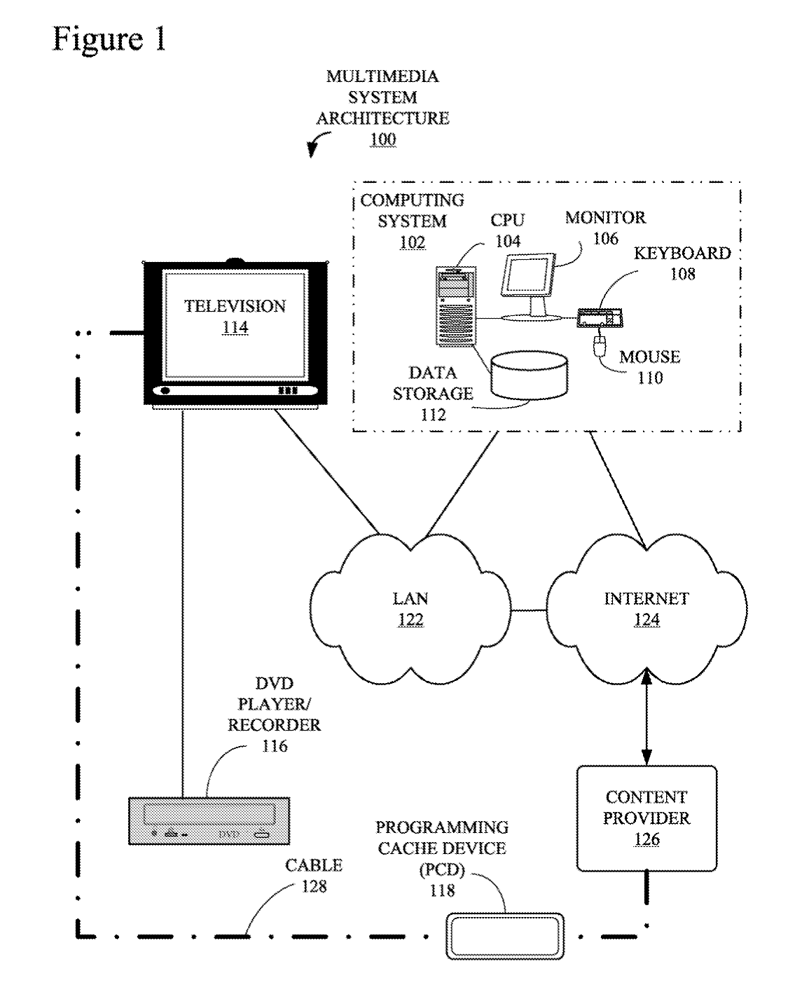

FIG. 1 is an exemplary multimedia system architecture 100 that includes a programming cache device (PCD) 118, implemented according to the claimed subject matter. Architecture 100 includes several devices, including a computing system 102, a television 114, and a DVD player/recorder 116. Devices 102 and 114 are communicatively coupled to a local area network (LAN) 122. The connections between LAN 122 and devices 102, 114 and 116 may be, but are not limited to, direct, wired connections, wireless connections or via a LAN hub (not shown). LAN 122 and computing system 102 are also coupled to the Internet 124. Device 114 is also communicatively coupled to Internet 124 via LAN 122. Those with skill in the computing and communication arts should appreciate that there are many possible methods for connecting devices to each other in addition to instead of LAN 122 and the Internet 124. The elements of FIG. 1 are used only for the purposes of describing the claimed subject matter and are not intended to limit the claims.

It should be noted that, although devices 102, 114 and 116 are illustrated as separate devices; a large degree of integration is possible. For example, the recording and playback capabilities of DVD player/recorder 116 may be incorporated into computing system 102 and/or television 114. Those with skill in the relevant arts should appreciate the extent to which the capabilities of such devices are currently, and may be, integrated into single units.

Computing system 102 includes a central processing unit (CPU) 104, coupled to a monitor 106, a keyboard 108 and a mouse 110, which together facilitate human interaction with computer 102. Also included in computer 102 and attached to CPU 104 is a data storage component 112, which may either be incorporated into CPU 104 i.e. an internal device, or attached externally to CPU 104 by means of various, commonly available connection devices such as but not limited to, a universal serial bus (USB) port (not shown).

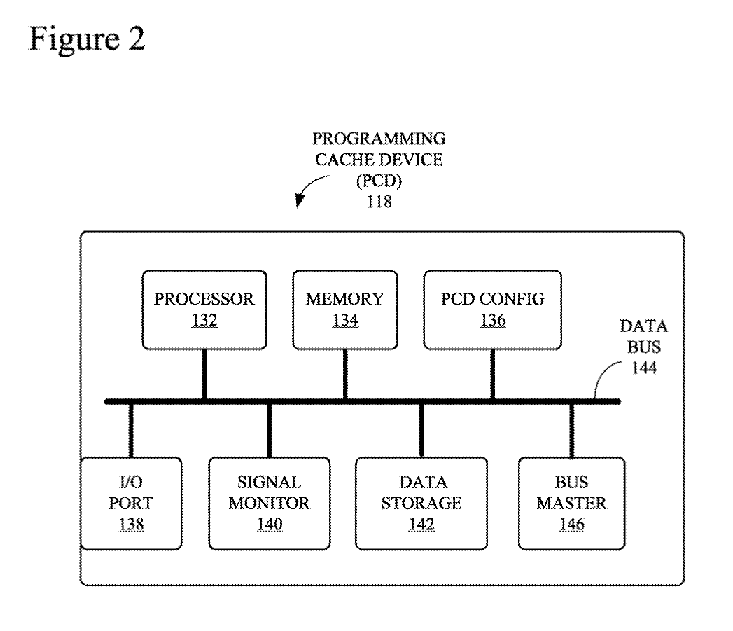

In this example, television 114 is Internet-enabled or, in other words, able to download an appropriate signal from Internet 124. Television 114 is also able to receive programming from a cable 128. Programming signals are transmitted by content provider 126 via Internet 124 or cable 128. In other words, content provider 126 may transmit programming to television via Internet 124, cable 128 or both. PCD 118, which in this example implements the claimed functionality, is illustrated as a stand alone device. It should be noted that in alternative embodiments PCD 118 and the associated functionality may be coupled to or incorporated into content provider 126, television 114, computing system 102 or a stand-alone device in the transmission path between television 114 and content provider 126 via Internet 124. Configuration and operation of PCD 118 are described in more detail below in conjunction with FIGS. 2-6.

FIG. 2 is a block diagram of PCD 118 of FIG. 1 in more detail. Functional modules include a processor 132, a memory 134, a PCD configuration (config.) module 136, an Input/Output (I/O) port 138, a signal monitor 140 and a data storage component 142. Each of modules 132, 134, 136, 138, 140 and 142 are coupled to a data bus 144, which enables modules 132, 134, 136, 138, 140 and 142 to communicate with each other. Traffic on data bus 144 is controlled by a bus master 146.

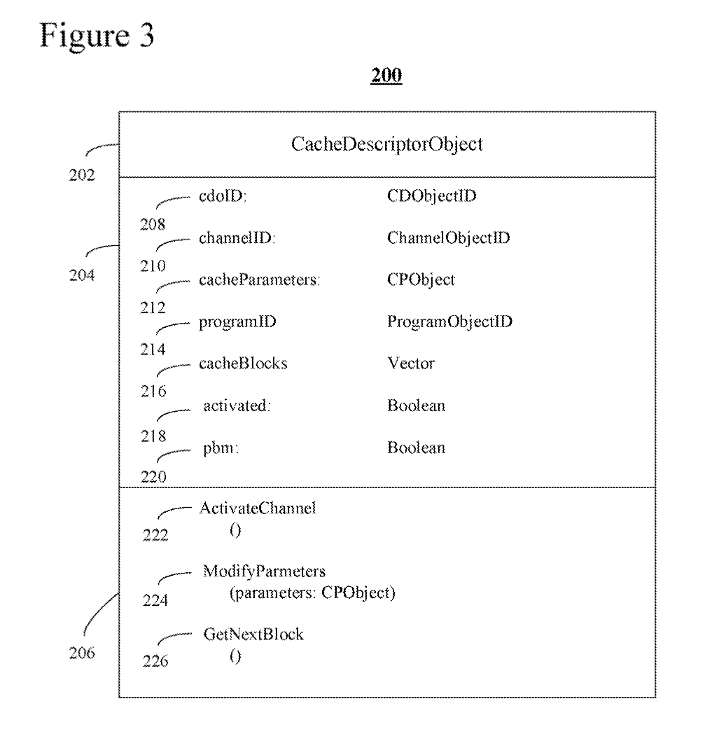

Processor 132 controls the coordination of modules 134, 136, 138, 140 and 142 while executing the claimed subject matter. Memory 134 provides storage for data and executables employed by processor 132. PCD configuration module 136 provides involatile storage for information employed in the claimed subject matter. Simply stated, module 136 stores information related to various programming streams to be monitored and cache as well as various caching options. The monitoring streams and caching options are described in more detail below in conjunction with FIGS. 3-6.

Input/Output (I/O) port 138 handles communication between PCD 118 and target devices such as television 114 (FIG. 1). Signal monitor 140 picks out specific signals to monitor based upon information stored in a CacheDescriptor object 200 (see FIG. 3). Data storage component 142 provides a data storage means in addition to memory 134. Data storage 142 typically has a larger data storage capacity than memory 134. Data storage 142 stores selected programming streams, each of which may take considerable storage and may be, but is not limited to, a hard disk drive. In this manner, the claimed subject matter enables a user to specify particular media streams to be cached such that when the user switches to a specific, cached data stream the programming on that stream can be displayed from the beginning of a segment rather than from the point in time at which switch is made.

FIG. 3 is an exemplary CacheDescriptorObject (CDO) memory object 200 employed in one implementation of the claimed subject matter. CDO memory object 200 includes a title section 202, which merely states the name of object 200, i.e. “CacheDescriptorObject,” an attribute section 204, which contains memory elements, or attributes, associated with CDO memory object 200, and a method section 206, which includes functions, or methods, that may be executed in conjunction with CDO memory object 200. It should be noted that the attributes and methods described are used for the purpose of illustration only. Additional and/or different attributes and methods may be employed to implement the claimed subject matter.

Attribute section 202 includes a “cdoID” attribute 208, a “channelID” attribute 210, a “cacheParameters” attribute 212, a “programID” attribute 214, a cacheBlocks attribute 216, an “activated” attribute 218, and a playback marker (PBM) attribute 220. Instantiations of object 200 are stored in PCD config 136 (FIG. 2) of PCD 118 (FIGS. 1 and 2).

CdoID attribute 208 is a variable of type CDObjectID that contains a reference to the particular instance of object 200. Each instance of object 200 has a unique value for attribute 208 that allows each instance to be uniquely identified. ChannelID attribute 210 is a variable of type ChannelObjectID that stores information to enable PCD 118 to identify a particular channel or media stream to be a target of the claimed subject matter. Examples of possible media streams are different channels received by television 114 (FIG. 1) or a radio station, either Internet 124 (FIG. 1) or broadcast. In other words, in the following example, a channel might be associated with an Internet 124 domain providing streaming media, a channel associated with cable 126 (FIG. 1) or a broadcast radio or television station.

CacheParameters attribute 212 is a variable of type CPObject that stores information for possible configurations for recording the channel specified in attribute 210. Logic associated with any particular configuration is typically stored in memory 134 and executed on processor 132, although specialized functions associated with a particular configuration may be stored and/or executed on one of the specialized modules 138, 140, 142 and 146 (FIG. 2). One example of the type of information stored in fields (not shown) of attribute 212 includes specific times or the day that the corresponding channel is recorded, or cached. Another example is information concerning the amount and block size of the cache. In other words, attribute 212 may include parameter information that specifies thirty (30) minutes of a corresponding channel is cached in one or two loops that are overwritten in turn. In the alternative, attribute 212 may specify that each program on the corresponding channel is cached from the beginning of each programming segment and the cache is erased following the segment. Programming information to implement the caching of programming segments can be downloaded from the associated content provider such as content provider 126.

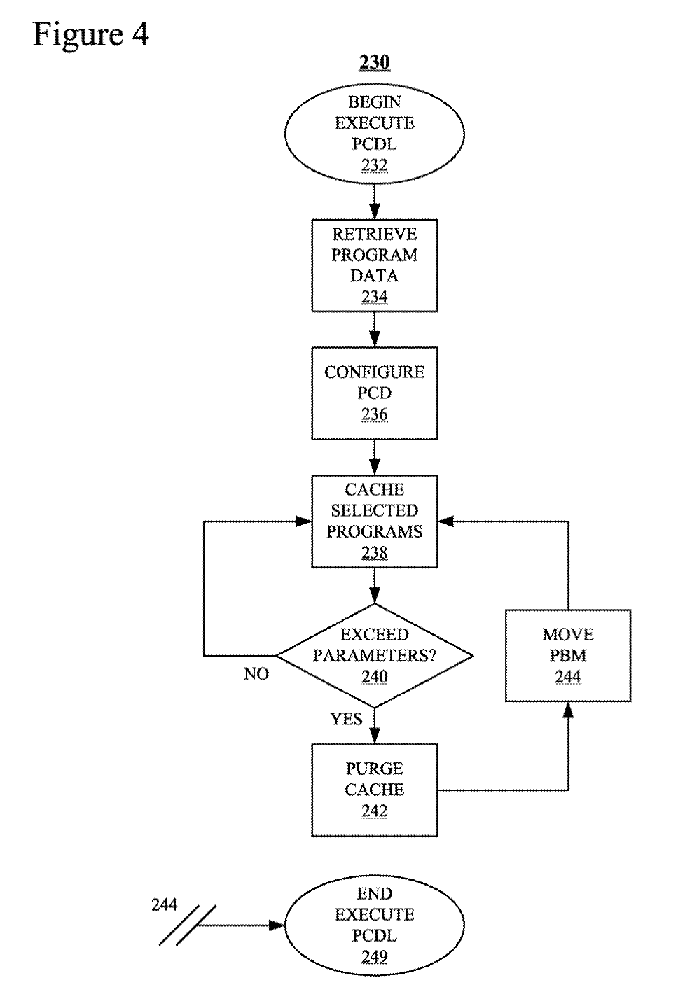

ProgramID attribute 214 is a variable of type ProgramObjectID that identifies a specific programming selection on the channel or media stream identified by channelID attribute 210. The identified programming selection is the target of the caching techniques described below in conjunction with FIGS. 4-6. In the alternative, attribute 214 may be left empty, indicating that the channel identified by attribute 210 is configured to be continuously cached, subject to the limitations identified in attribute 212. For example, a particular channel may be cached such that the last hour or two of programming is always available in a corresponding cache.

CacheBlocks attribute 216 is a variable of type Vector. Attribute 216 stores a linked series of pointers, each of which point to a block of stored content (not shown) corresponding to a portion of the selected programming identified by programID attribute 214. The setup of attribute 216 is explained in more detail below in conjunction with FIG. 4. In short, attribute 216 enable PCD 118 to retrieve stored programming by identifying the location of a chain of stored content blocks.

Activated attribute 218 is a variable of type Boolean that stores a value indicating whether or not the CDO object 200 associated with cdoID 208 is currently active. In other words, PCD 118 provides the ability to define channels and corresponding caching schemes that may be executed in the future but are currently inactive. PBM attribute 220 is a variable of type Boolean that stores a value indicating whether or not the CDO object 200 associated with cdoID 208 is associated with a playback marker object (not shown). The use of playback markers is described in more detail below in conjunction with FIGS. 4-6.

Method section 206 of object 200 includes three (3) exemplary functions, or methods; i.e. an “ActivateChannel” method 222, a “ModifyParameters” method 224 and a “GetNextBlock” method 226. Methods 222, 224 and 226 are described in more detail below in conjunction with FIGS. 4-6. Simply stated, ActivateChannel method 222 is executed to turn on or off the caching of the corresponding channel. ModifyParameters method 224 is to specify a particular channel and program and define the parameters stored in attribute 212 that control the associated caching. GetNextBlock method 226 is executed to retrieve a particular block, typically the next unaccessed block stored in cacheBlocks attribute 216.

Only three methods are illustrated for the sake of simplicity. Those with skill in the programming arts should appreciate that an object such as object 200 would typically include many additional methods including, but not limited to, constructors, destructors, and methods to set and get values for various attributes. It should be understood that CDO object 200 is only one example of a memory object that may be used to implement the claimed subject matter. Other memory objects with fewer, more and/or different attributes and methods may be employed. In addition, there are many ways other than employing object 200 to implement the functionality and data storage of the claimed subject matter. For example, the claimed subject matter may be implemented by means of a computer program in conjunction with a relational database.

FIG. 4 is a flowchart of an exemplary Execute Program Cache Device Logic (PCDL) process 230 for implementing one embodiment of the claimed subject matter. In the embodiment exemplified by FIG. 4, the caching is performed by PCD 118 (FIGS. 1 and 2). Process 230 executes on processor 132 (FIG. 2) of PCD 118 and is stored in memory 134 (FIG. 2).

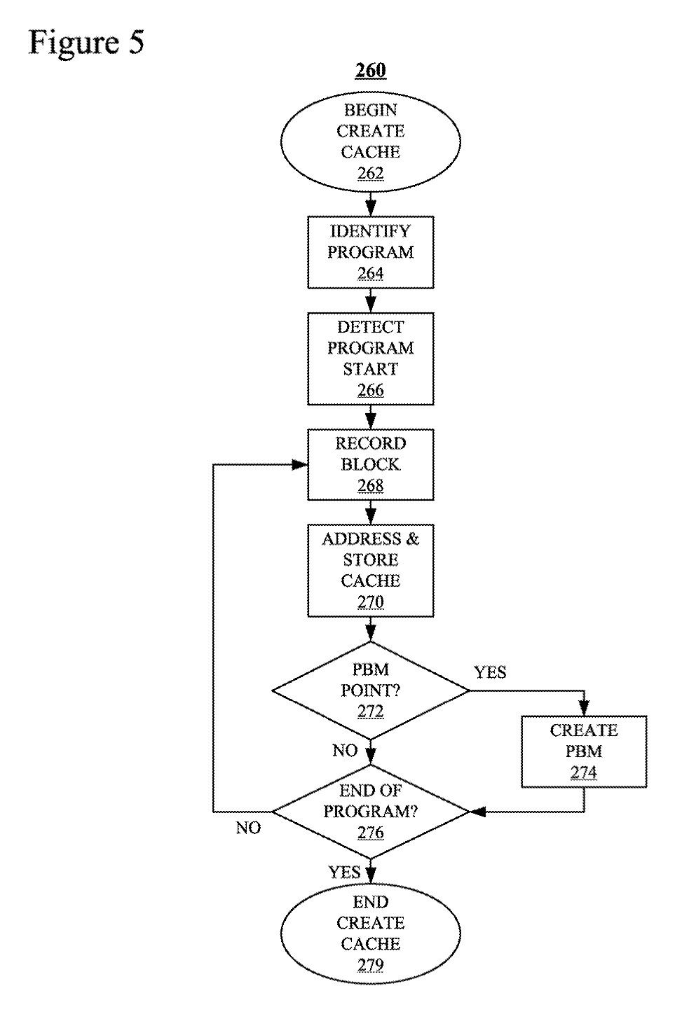

Process 230 starts in a “Begin Execute PCDL” block 232 and control proceeds immediately to a “Retrieve Program Data” block 234. During block 234, process 230 downloads configuration information such as data stored in instances of ChacheDescriptorObject (CDO) memory object 200 (FIG. 3) from PCD configuration module 136 (FIG. 2). Memory objects 200 corresponding to particular media streams the user has designated to be of interest are loaded into memory 134 (FIG. 2). During a “Configure PCD” block 236, process 230 employ memory objects 200, downloaded during block 234 to identify specific media streams to be saved to data storage 142 (FIG. 2) during a “Record Selected Programs” block 238. Record selected programs block 238 is implemented in part by a Create Cache process 260 described below in conjunction with FIG. 5. Each program recorded during block 238 corresponds to a CDO memory object 200. In the alternative, rather than or in addition to selected programs, the claimed subject matter is configured to record and cache specific, identified channels with corresponding parameters that specify the size of the particular cache.

During an “Exceed Parameters?” block 260, process 230 determines whether or not any limits such as storage capacity of PCD 118 have been exceeded. If so, control proceeds to a “Purge Cache” block 242 during which process 230 cleans up memory and then proceeds to a “Move playback marker (PBM)” block 244. During block 244, PCMs associated with portions of the cache that are purged are moved to appropriate memory blocks that have not been purged. Process 230 then returns to block 236, reconfigures and proceeds as described above. If during block 240, process 230 determines that parameters have not been exceeded, control returns to block 238 and processing continues as described above.

Finally, since process 230 is designed to operate continuously while PCD 118 is powered on, an asynchronous interrupt 244 is initiated to terminate process 230. Interrupt 244 causes process 230 to proceed to an “End Execute PRDL” block 249 in which process 230 is complete.

FIG. 5 is a flowchart of an exemplary Create Cache process 260 for implementing one aspect of the claimed subject matter. Process 260 is employed during Record Selected Programs block 238 (FIG. 4) of Execute PCDL process 230 (FIG. 4). In the following example, process 260 is stored in memory 134 (FIG. 2) of PCD 118 (FIGS. 1 and 2) and executed on processor 132. It should be noted that the claimed subject matter could be executed and the results stored in a wide variety of platforms and architectures.

Process 260 starts in a “Begin Create Cache” block 262 and proceeds immediately to an “Identify Program” block 264. During block 264, process 260 retrieves a CDO object 200 (FIG. 3) corresponding to a particular programming selection that is the target of the claimed subject matter. As explained above in conjunction with FIG. 3, the specific programming selection is identified by the information stored in attributes 210 and 214 (FIG. 3). Typically, PCD 118 includes a calendar/alarm type of program (not shown) for identifying instances of CDO 200 that require processing at any particular time.

During a “Detect Program Start” block 266, process 260 determines that the program identified by CDO object 200 retrieved during block 264 has commenced. Process 260 then proceeds to an “Record Block” block 262 during which process 260 stores the transmitted programming into a storage block of a type and size specified by the information stored in cacheParameters attribute 212 (FIG. 3). Once the storage block generated during block 268 has reached the limits specified by attribute 212, process 260 proceeds to an “Address and Store Cache” block 270. During block 270, process 260 assigns an address to the storage block recorded during block 268 and saves the storage block into a memory, which in this example is data storage 142 (FIG. 3). In addition to the saving of the storage block, a reference to the block is added to the linked list stored in cacheBlocks attribute 216 (FIG. 3).

During a “PBM point?” block 272, process 260 determines whether or not the block cached and addressed during block 270 represents a point in the programming segment from which a playback is configured to be initiated. Examples of playback points include, but are not limited to, the beginning of programs and at point in the program following a commercial or other interruption. If process 260 determines that the block represents a playback point, process 260 proceeds to a “Create playback marker (PCM)” block 274. During block 274, process 260 creates a PCM data object (not shown), associates the PCM data object with the data block created during block 270 and sets pbm attribute 220 (FIG. 3) in the corresponding CDO data object 200 to indicate the association.

Following block 274, or if process 260 determines during block 272 that a playback marker is not required, control proceeds to an “End of Program?” block 276. During block 276, process 260 determines whether or not the targeted program has concluded or the storage parameters limits defined by attribute 212 have been exceeded. In other words, although a particular program may be one (2) hours in length, attribute may specify that only one (1) hour be stored in a corresponding cache. If the program has concluded or the storages parameters have been exceeded, process 260 returns to block 268 and continues recording as described above. Finally, if process 260 determines that the recording should end, control proceeds to an “End Create Cache” block 279 during which process 260 is complete.

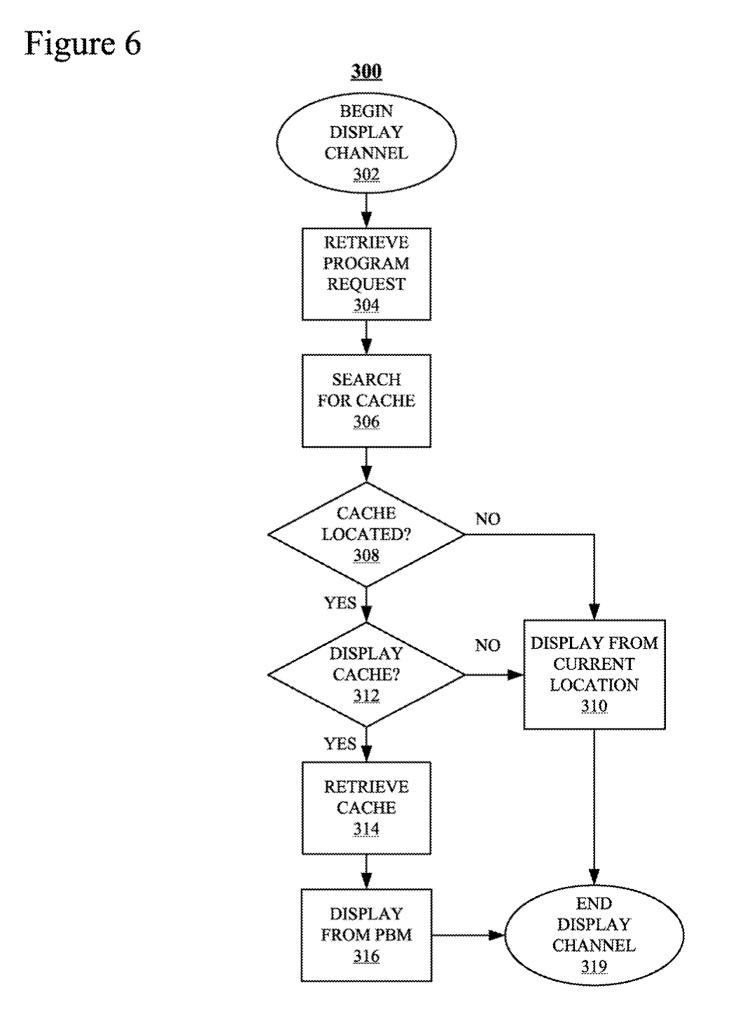

FIG. 6 is a flowchart of a Display Channel process 300 employed to implement one aspect of the claimed subject matter. In the embodiment exemplified by FIG. 6, process 300 is executed by PCD 118 (FIGS. 1 and 2). Process 300 is initiated by a request transmitted by a user of television 114 (FIG. 1) for a particular program. Process 300 executes on processor 132 (FIG. 2) of PCD 118 and is stored in memory 134 (FIG. 2).

Process 300 starts in a “Begin Display Channel” block 302 and proceeds immediately to a “Retrieve Program Request” block 304. As explained above, process 300 is initiated by a request transmitted from television 114. A request typically is transmitted when a user of television 114 changes channels such that a new program is selected for viewing. A request may be transmitted via LAN 122 (FIG. 1) and Internet 124 (FIG. 1), in the case of an IP-enable television, or via cable 128 (FIG. 1), in a cable-enabled television.

During a “Search for Cache” block 306, process 300 scans memory 134 for a CDO memory object 200 (FIG. 3) that corresponds to the program selected for viewing. During a “Cache Located?” block 308, process 300 determines whether or not a corresponding memory object 200, representing a cache, is located. If a corresponding memory object 200 is not located, process 300 proceeds to a “Display From Current Location” block 310. During block 310 the selected programming is simply displayed from the current location in the transmission. In other words, if the selected programming is half completed, only the second half is transmitted to television 114 for viewing.

If during block 308, process 300 determines that a corresponding cache exists, control proceeds to a “Display Cache?” block 312. During block 312 process 300 displays a graphical user interface (GUI) (not shown) on television 114 that enables a user to choose whether or not to view the selected programming from the current location in the transmission or from the cache. If the user chooses to view the program form the current location, process 300 proceeds to block 310 and processing continues as described above.

If during block 312 the user chooses to view the selected program from the cache, process 300 proceeds to a “Retrieve Cache” block 314. During block 314, process 300 stores the corresponding cache in memory 134 to control the transmission of the corresponding program to television 114. During a “Display From playback marker (PCM)” block 316, process 260 locates a cache block associated with the appropriate PBM, iteratively executes GetNextBlock method 226 (FIG. 3) to retrieve the corresponding cache data blocks and transmits the storage blocks identified by cacheBlocks attribute 216 (FIG. 3). The storage blocks are transmitted in the same order as recorded, beginning with the first storage block in the cache associates with a PBM. It should be noted that, as the storage blocks are transmitted to television 114 additional blocks are added to the end of the corresponding cache so that the entire program may be transmitted as though started from the beginning. Finally, once the transmission of the programming is complete, control proceeds to an “End Display Channel” block 319 in which process 300 is complete.

The claimed subject matter may also be configured to enable a user to fast forward through or skip segments of programming. For example, during a commercial in a television program, a signal from the user initiates one or more calls to GetNextBlock method 226 prior to the completion of a current block, thus enabling PCD 118 to transmit programming either faster than normal speed or in a manner that skips undesirable programming.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A computer implemented method for selecting media content, the method comprising:
receiving a plurality of transmitted media content, wherein the media content includes a playback marker and an indication of current content;
converting the plurality of media content into a plurality of addressable data blocks;
identifying a current block from the plurality of addressable data blocks using the indication of current content;
identifying a playback block from the plurality of addressable data blocks using the playback marker;
determining whether the current block corresponds to the playback block; and,
in response to determining that current block does not correspond to the playback marker, retrieving the playback block.

2. The method of claim 1, wherein retrieving the playback block further comprises:
selecting, via a graphical user interface (GUI), to retrieve the current block rather than the playback block; and
marking the current block as the playback block; and
retrieving the playback block.

3. The method of claim 1, wherein the media content is an Internet Protocol television stream (IPTV).

4. The method of claim 1, wherein the media content is an audio transmission stream.

5. The method of claim 1, wherein the indication of current content comprises a time value associated with the transmission of the current content, and wherein the playback marker comprises another time value used to identify a beginning segment of the media content.

6. The method of claim 1, further comprising:
defining a specific interval of time;
discarding a data block corresponding to the earliest point in a chronological order corresponding to the addressable data blocks when a playback time representing remaining data blocks exceeds the defined interval of time; and
associating the playback marker with an addressable data block corresponding to the earliest point in a chronological order of remaining data blocks of the plurality of addressable data blocks.

7. The method of claim 1, further comprising:
selecting a plurality of streams corresponding to a particular media content provider;
applying the receiving and converting and addressing to the plurality of selected streams; and
applying the retrieving and transmitting to stored data blocks associated with at least one of the selected streams.

8. A system for selecting media content, comprising:
a media delivery device for delivery of programming content;
logic for receiving a plurality of transmitted media content, the media content, comprising:
a playback marker; and
an indication of current content;
logic for converting the plurality of media content into a plurality of addressable data blocks;
logic for identifying a current block from the plurality of addressable data blocks using the indication of current content;
logic for identifying a playback block from the plurality of addressable data blocks using the playback marker;
logic for determining whether the current block corresponds to the playback marker; and,
logic for retrieving the playback block if the current block does not correspond to the playback marker.

9. The system of claim 8, further comprising:
a graphical user interface (GUI), the GUI comprising logic for electing to retrieve the current block rather than the playback block;
logic for selecting, via the graphical user interface (GUI), to retrieve the current block rather than the playback block;
logic for marking the current block as the playback block; and
logic for displaying the playback block.

10. The system of claim 8, wherein the media content is an Internet Protocol television stream (IPTV).

11. The system of claim 8, wherein the media content is an audio transmission stream.

12. The system of claim 8, the indication of current content comprises a time value associated with the transmission of the current content, and the playback marker comprises another time value used to identify a beginning segment of the media content.

13. The system of claim 8, further comprising:
a defined interval of time;
logic for discarding a data block corresponding to the earliest point in a chronological order corresponding to the addressable data blocks when the playback time representing by remaining data blocks exceeds the defined interval of time; and
logic for associating a playback marker with an addressable data block corresponding to the earliest point in a chronological order of remaining data blocks of the plurality of addressable data blocks.

14. The system of claim 8, further comprising:
logic for selecting a plurality of streams corresponding to a particular media content provider;
logic for applying the receiving and converting and addressing to the plurality of selected streams; and
logic for applying the retrieving and transmitting to stored data blocks associated with at least one of the selected streams.

15. A method for providing the service of delivery of media programming, comprising:
converting a plurality of transmitted media content into a plurality of addressable data blocks wherein the media content includes a playback marker and an indication of current content;
receiving a request for one addressable data block from the plurality of addressable data blocks;
identifying a current block from the plurality of addressable data blocks using the indication of current content;
identifying a playback block from the plurality of addressable data blocks using the indication of playback marker;
determining whether the current block corresponds to the playback block; and,
in response to determining that current block does not correspond to the playback block, transmitting the playback block.

16. The method of claim 15, further comprising:
generating a graphical user interface (GUI) to enable the user to specify whether to retrieve the playback block or the current block.
selecting, via a graphical user interface (GUI), to retrieve the addressable data block that corresponds to the current block;
marking the current block as the playback block; and
transmitting the playback block.

17. The method of claim 15, wherein the media content is an Internet protocol television stream (IPTV).

18. The method of claim 15, wherein the media content is an audio transmission stream.

19. The method of claim 15, further comprising:
identifying the beginning of the media content;
associating the playback marker with the beginning of the media content; and
associating the indication of current content with the media content being transmitted at a particular time.

20. The method of claim 15, further comprising:
defining a specific interval of time;
discarding a data block corresponding to the earliest point in a chronological order corresponding to the addressable data blocks when the playback time representing by remaining data blocks exceeds the defined interval of time; and
associated the playback marker with an addressable data block corresponding to the earliest point in a chronological order of remaining data blocks of the plurality of addressable data blocks.
